(19) United States
(12) Patent Application Publication
(10) Pub. No.: US 2012/0171539 A1
(43) Pub. Date: Jul. 5, 2012

(54) Handheld machine tool energy supply unit

(76) Inventors: Marcin REJMAN, Waiblingen (DE); Rainer Glauning, Leinfelden-Echterdingen (DE); Thorsten Seidel, Remseck (DE)

(21) Appl. No.: 13/337,620

(22) Filed: Dec. 27, 2011

(30) Foreign Application Priority Data
Jan. 3, 2011 (DE) 10 2011 002 404.2

(51) Int. Cl. H01M 2/10

(52) U.S. Cl. 429/99; 429/100

(57) ABSTRACT

A handheld machine tool energy supply unit, particularly a battery pack or an accumulator pack having an accumulator unit and an interface element, is described. The handheld machine tool energy supply unit includes a damping unit, which is provided for supporting the accumulator unit in an oscillation-damped manner.

### RELATED APPLICATION INFORMATION

The present application claims priority to and the benefit of German patent application no. 10 2011 002 404.2, which was filed in Germany on Jan. 3, 2011, the disclosure of which is incorporated herein by reference.

### FIELD OF THE INVENTION

The present invention relates to a handheld machine tool energy supply unit.

### BACKGROUND INFORMATION

Handheld machine tool energy supply units are known, particularly battery or accumulator packs, having an accumulator unit and an interface element.

### SUMMARY OF THE INVENTION

The exemplary embodiments and/or exemplary methods of the present invention relate to an handheld machine tool energy supply unit, particularly a battery pack or accumulator pack having an accumulator unit and an interface element. By “handheld machine tool energy supply unit” one should particularly understand a unit provided to supply an handheld machine tool especially with electrical energy. One may understand by this a battery pack or accumulator pack. In a particular manner, the handheld machine tool energy supply unit is implemented as a unit that is exchangeable by the user, which is connected to an handheld machine tool via an interface. The handheld machine tool energy supply unit may include an accumulator unit that contains one or more battery or accumulator cells, and an interface unit using which the handheld machine tool energy supply unit is connected mechanically or electrically to an handheld machine tool. By “handheld machine tool” one should understand particularly a machine processing a workpiece, such as, in particular, a drilling machine, a hammer drill, a percussion drill, a saw, such as a compass saw or saber saw, a screwdriver, a milling machine, a grinder, an angle sander, an orbital sander, a gardening tool and/or a multifunctional tool, etc.

It is provided that the handheld machine tool energy supply unit include a damping unit which is provided for supporting the accumulator unit in a vibration-damped manner. By “damping unit” one should understand a unit that is suitable for clearly reducing the transmission of an oscillation and/or vibration from the handheld machine tool and/or parts of the handheld machine tool energy supply unit to the accumulator unit. The damping unit includes damping and/or spring elements which clearly lessen the accelerations acting on the accumulator unit. By “clearly reduce” it should be understood that, particularly, the maximum acceleration of the oscillation or vibration, that is acting on the accumulator unit, is reduced by at least 50%, which may be by more than 80%. The damping unit may transform a part of the oscillating energy into heat, by having an entropy-elastic behavior. In response to alternating stress by oscillation or vibration, the damping unit may demonstrate hysteresis, that is, in the stress-expansion diagram, the loading curve does not correspond to the unloading curve. Because of the conversion of mechanical oscillation energy into heat, a part of the kinetic energy is absorbed. It may advantageously be achieved that the accumulator unit is protected from oscillation or vibration of the handheld machine tool. The mechanical robustness can be increased. The sensitive battery or accumulator cells of the accumulator unit can be treated with care. The service life and the reliability of the handheld machine tool energy supply unit can be increased. Wear can be reduced. Safety is able to be improved. In particular, the risk of a short circuit of a battery cell or an accumulator cell or of the accumulator unit is able to be reduced.

The damping unit may connect the accumulator unit to the interface element in a damped manner. By this one should particularly understand that the accumulator unit is supported in a damped manner by the damping unit in the interface element and/or, in at least one operating state, a supporting force of the accumulator unit is supported via the damping unit on the interface element. The damping unit may be the only connection between the accumulator unit and the interface element. However, there may also be provided additional connections between the interface element and the accumulator unit. In particular, safety elements may be provided which prevent the accumulator unit from becoming detached from the interface element. Safety elements may be configured to be flexurally soft, and do not transmit any substantial oscillation or vibration from the interface element to the accumulator unit. Safety elements may be developed as wires or cords, for example. An advantageous oscillation damping of the accumulator unit may be achieved. Because of the supporting of the accumulator unit by the damping unit, component parts may be saved.

Furthermore, it is provided that the damping unit is at least partially developed from an elastomeric material. By “elastomeric material” one should understand an entropy-elastic elastomeric material having a distinct hysteresis, which is used above its glass transition temperature. An elastomeric material having a distinct hysteresis advantageously converts a great deal of mechanical oscillation energy to heat, since for compression, a substantially higher mechanical energy is required than it gives off again during subsequent unloading during the return to its initial shape. The elastomeric material may be a cross-linked elastomeric material. The elastomeric material particularly has a flat spring characteristics line. The damping unit may be configured at least partially from a foam material made of an elastomeric material. A foam material made of an elastomeric material has a particularly distinct hysteresis, and converts a particularly great quantity of oscillation energy to heat. An especially good oscillation damping can be achieved.

The handheld machine tool energy supply unit may have at least one contact unit that is rigidly situated on the accumulator unit. Contact unit should be understood to mean a unit provided to connect the accumulator unit to the handheld machine tool at least electrically. The handheld machine tool has a contact holder which is mechanically and electrically suitable for contacting the contact unit of the accumulator unit, by the contacts of the contacting unit and the contacts of the contact holder touching each other. By “rigidly situated” it should be understood that the contact unit is connected to the accumulator unit essentially nondetachably, and/or is a component of the accumulator unit. The connection need have no damping and/or spring elements. The damping of the contact unit is particularly less than 50%, which may be less than 10% than the damping by the damping unit that is provided for the oscillation damping of the accumulator unit of the handheld machine tool energy supply unit. A particularly safe connection may be achieved of the contact unit to the accumulator unit. In particular, the electrical connections of the accumulator unit between the battery cells or the accumulator cells and the contact unit are loaded only a little. In one additional embodiment of the present invention, a damping unit may be provided which connects the contact unit to the accumulator unit in a damped manner. The contact unit can be situated rigidly on the interface element, which is connected in a damped manner to the accumulator unit via a damping unit. If a damping unit is provided between the contact unit and the accumulator unit, the contact unit may be connected to the accumulator unit using flexible conductors. The accumulator unit may be protected from vibrations and oscillations of the interface element and the contact unit, using a damping element.

It is provided that the handheld machine tool energy supply unit have at least one locking element situated on the interface element, which is provided to connect the interface element rigidly to an handheld machine tool. By “locking element” one should understand particularly an element that is provided to be brought into contact to be locked to another locking element, so that a locking force is able to be transmitted via the two locking elements. For this purpose, the handheld machine tool has a locking element to which the locking element of the handheld machine tool energy supply unit is connected. By “connect rigidly” it should be understood that, in the locked state, the connection between the interface element and the handheld machine tool may have no damping element and/or spring element. The damping of the connection between the interface element and the handheld machine tool is particularly less than 50%, which may be less than 10% of the damping of the damping unit that is provided for the oscillation damping of the accumulator unit of the handheld machine tool energy supply unit. A particularly secure connection may be ensured between the interface element and the handheld machine tool. The interface element may be a part of a protective housing of the handheld machine tool energy supply unit. The oscillation-damped supported accumulator unit may be protected particularly effectively on the inside of an appropriate protective housing.

Furthermore, an handheld machine tool is provided having an interface for connecting to an handheld machine tool energy supply unit, the interface including at least one damping unit. By “damping unit” we mean a unit, situated on the interface of the handheld machine tool, which is provided so as clearly to reduce the transmission of an oscillation or vibration from the handheld machine tool to the handheld machine tool energy supply unit or to parts of the handheld machine tool energy supply unit. The damping unit may be formed from an elastomeric material. The transmission of vibration or oscillation to the handheld machine tool energy supply unit is able to be reduced effectively.

The interface of the handheld machine tool may have a contact holder which has the damping unit, and the former is provided for the oscillation-damped contacting of a contact unit of the handheld machine tool energy supply unit. In an especially particular manner, the damping unit may be situated between an handheld machine tool housing and a contact of the contact holder and/or the damping unit supports the contact holder on the handheld machine tool housing. The damping unit may be elastic, and, in the operating state, it exerts a force in the direction of the contact unit of the accumulator unit. A particularly secure contact is able to be ensured thereby. The damping unit may be made at least partially of an elastomeric material, particularly of an entropy-elastic elastomeric material. It particularly may be the case that if the damping unit is configured at least partially from a foam material made of an elastomeric material. The damping unit is able to include elements which increase the reliability of a contact force between the contact holder and the contact unit of the accumulator unit. In particular, the damping unit may include spring elements. One may thus effectively reduce the transmission of a vibration or oscillation particularly to a contact unit that is mounted rigidly on the accumulator unit of the handheld machine tool energy supply unit. A particularly secure contacting is able to be ensured thereby.

It is further provided that the interface of the handheld machine tool has at least one locking element to the damping unit, which is provided to form an oscillation-damped locking of the handheld machine tool energy supply unit. By “oscillation-damped locking” one should understand locking having great damping corresponding to the damping unit of the handheld machine tool energy supply unit provided. An effective oscillation damping may be achieved in handheld machine tool energy supply units which do not have a sufficient oscillation damping themselves.

Furthermore, a system is provided having an handheld machine tool energy supply unit and an handheld machine tool.

Further advantages are derived from the description of the figures that follow. The drawing shows exemplary embodiments of the present invention. The drawings, the description, and the claims include numerous features in combination. One skilled in the art will expediently consider the features also individually, and will combine them into useful further combinations.

### BRIEF DESCRIPTION OF THE DRAWINGS

FIG. 1 shows a schematic representation of an handheld machine tool energy supply unit and an handheld machine tool.

FIG. 2 shows a schematic representation of an handheld machine tool energy supply unit having a damping unit.

FIG. 3 shows a schematic representation of an handheld machine tool energy supply unit in a second exemplary embodiment.

FIG. 4 shows a schematic representation of an handheld machine tool energy supply unit and an handheld machine tool in a third exemplary embodiment.

FIG. 5 shows a schematic representation of an handheld machine tool energy supply unit and an handheld machine tool in a fourth exemplary embodiment.

### DETAILED DESCRIPTION

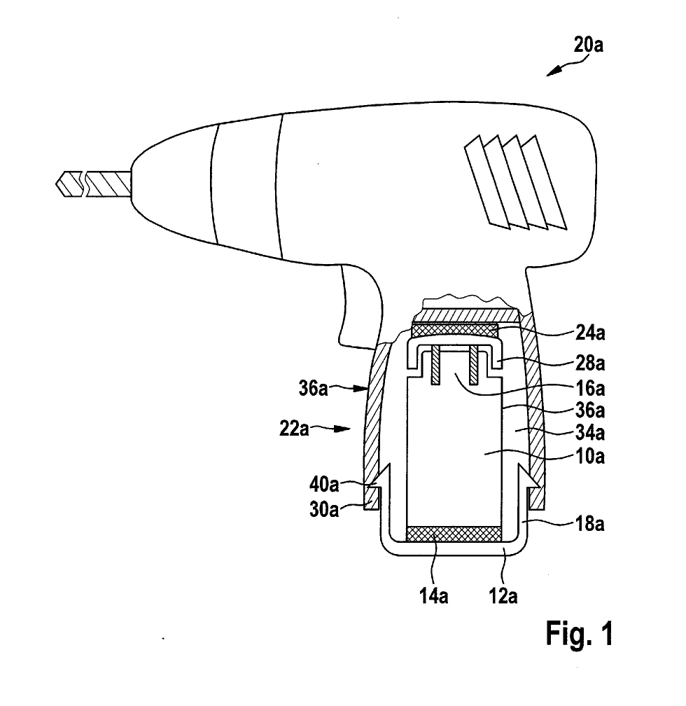

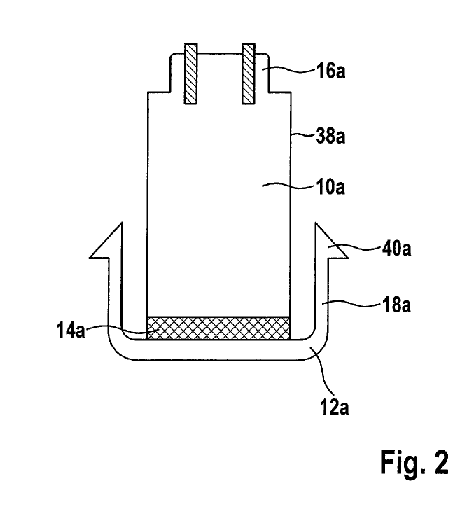

FIGS. 1 and 2 show a system having an handheld machine tool energy supply unit and an handheld machine tool 20a. The handheld machine tool energy supply unit is embodied as an accumulator pack and includes an accumulator unit 10a, an interface element 12a and a damping unit 14a, which is provided to support accumulator unit 10a in an oscillation-damped manner. Damping unit 14a connects accumulator unit 10a to interface element 12a in a damped manner. Damping unit 14a may be formed of an elastomeric material. In the example shown, damping unit 14a is made of a foam material that is made of an elastomeric material. Damping unit 14a is adhered to interface element 12a and accumulator unit 10a. A contact unit 16a is rigidly situated on accumulator unit 10a. Contact unit 16a includes the electrical contacts required for the operation of accumulator unit 10a, and is a part of a housing 38a of accumulator unit 10a. An interface 22a on a housing 36a of handheld machine tool 20a is used to connect to the handheld machine tool energy supply unit, and includes a damping unit 24a. A locking element 18a is situated on interface element 12a, which rigidly connects interface element 12a to interface 22a of handheld machine tool 20a. Locking element 18a is designed in one piece with interface element 12a, and is made up of a flexible plastic element having latches 40a. In order to connect it, the user guides the handheld machine tool energy supply unit into a recess 34a of interface 22a on housing 36a of handheld machine tool 20a. A locking element 30a of interface 22a engages with locking element 18a of interface element 12a, and locks handheld machine tool energy supply unit rigidly with housing 36a of handheld machine tool 20a. A contact holder 28a of interface 22a has damping unit 24a. Contact holder 28a is provided to form an oscillation-damped contacting of contact unit 16a of handheld machine tool energy supply unit. Damping unit 24a is made of an elastomeric foam material and is adhered to housing 36a and contact holder 28a. Contact unit 16a of handheld machine tool energy supply unit is pressed against contact holder 28a of interface 22a, so that an electrical contact is produced between accumulator unit 10a and handheld machine tool 20a. Accumulator unit 10a is able to supply handheld machine tool 20a with electrical energy. Accumulator unit 10a is supported elastically float-mounted via damping unit 14a of interface element 12a and via contact unit 16a and contact holder 28a via damping unit 24a of handheld machine tool 20a. Vibrations and oscillations of handheld machine tool 20a are transmitted in a damped manner to accumulator unit 10a only via the two damping units 14a and 24a. Contact unit 16a is connected electrically to accumulator cells of accumulator unit 10a. In accumulator unit 10a, additional components may be included, that are not shown in greater detail, that are needed for operating accumulator unit 10a, such as components for monitoring the charging state. Contact unit 16a includes additional contacts that are used for charging accumulator unit 10a.

The following description and the drawings of additional exemplary embodiments are limited essentially to the differences between the exemplary embodiments; with reference to components designated the same way, particularly with reference to components having the same reference numerals, especially with reference to the drawings and/or the description of the other exemplary embodiments, one is basically also able to refer to the drawings and/or the description of the other exemplary embodiments.????? To distinguish the exemplary embodiments, instead of the letter a for the first exemplary embodiment, letters b, c and d of the additional exemplary embodiments are appended.

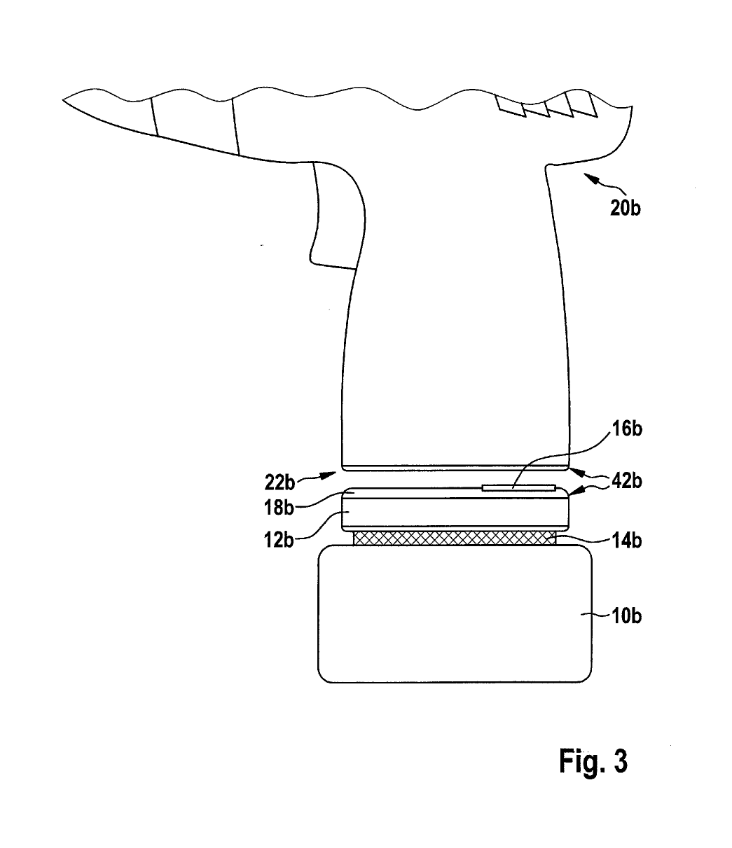

FIG. 3 shows a further embodiment of an handheld machine tool energy supply unit. The handheld machine tool energy supply unit includes an accumulator unit 10b that is connected to an interface element 12b by a damping unit 14b. A contact unit 16b is situated rigidly on interface element 12b, and is electrically connected to accumulator unit 10b using flexible conductors that are not shown. The handheld machine tool energy supply unit is plugged onto an interface 22b of an handheld machine tool 20b, via a locking element 18b which also includes the contact elements and is developed as a spring-groove connection 42b. Interface 22b also includes contacts, that are not shown, for the electrical connection of interface 22b to contact unit 16b. Other embodiments familiar to one skilled in the art, of an interface 22b between an handheld machine tool energy supply unit and an handheld machine tool 20b, are also possible. In this embodiment of the present invention, only one damping unit 14b is required, since contact unit 16b is situated on interface element 12b.

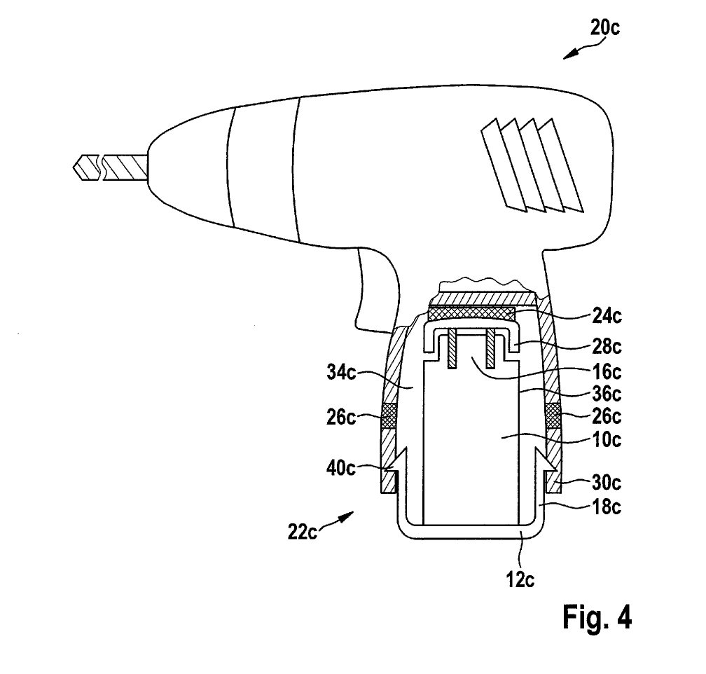

FIG. 4 shows a system having an handheld machine tool energy supply unit and an handheld machine tool 20c having a locking element 30c of an interface 22c that has a damping unit 26c, which is provided to yield an oscillation-damped locking of an handheld machine tool energy supply unit having an interface element 12c that matches interface 22c. Damping unit 26c is produced from an elastomeric material, and is situated between a housing 36c of handheld machine tool 20c and locking element 30c. Housing 36c, damping unit 26c and locking element 30c are produced in one piece in a multi-component injection molding method. A contact holder 28c of interface 22c has a damping unit 24c. Contact holder 28c is provided to form an oscillation-damped contacting of contact unit 16c of handheld machine tool energy supply unit. An accumulator unit 10c of handheld machine tool energy supply unit is protected by damping unit 26c and damping unit 24c of interface 22c from vibrations or oscillations of handheld machine tool 20c.

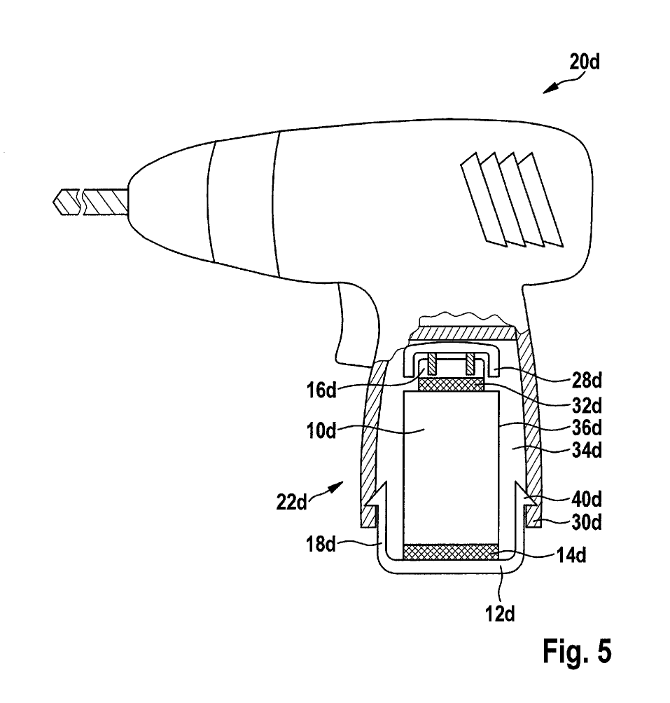

FIG. 5 shows a system having an handheld machine tool energy supply unit and an handheld machine tool 20d in a third exemplary embodiment. The handheld machine tool energy supply unit is embodied as an accumulator pack and includes an accumulator unit 10d and an interface element 12d having a damping unit 14d, which is provided to support accumulator unit 10d in an oscillation-damped manner. Damping unit 14d connects accumulator unit 10d to interface element 12d in a damped manner. An additional damping unit 32d connects a contact unit 16d to accumulator unit 10d. Damping unit 32d is made of an elastomeric foam material and is adhered to accumulator unit 10d and contact unit 16d. In addition, contact unit 16d is electrically connected to accumulator unit 10d, using flexible lines that are not shown. Accumulator unit 10d is protected from vibrations or oscillations of handheld machine tool 20d by damping unit 14d.

What is claimed is:

1. An handheld machine tool energy supply unit, comprising:
an accumulator unit; and
an interface element having at least one damping unit to support the accumulator unit in an oscillation-damped manner.

2. The handheld machine tool energy supply unit of claim 1, wherein the damping unit connects the accumulator unit to the interface element in a damped manner.

3. The handheld machine tool energy supply unit of claim 1, wherein the damping unit is made at least partially of an elastomeric material.

4. The handheld machine tool energy supply unit of claim 1, wherein at least one contact unit is situated rigidly on the accumulator unit.

5. The handheld machine tool energy supply unit of claim 1, wherein at least one locking element is situated on the interface element to connect the interface element rigidly to an handheld machine tool.

6. A handheld machine tool, comprising:
an interface, having at least one damping unit to support an accumulator unit in an oscillation-damped manner, for connecting to an handheld machine tool energy supply unit having the accumulator unit.

7. The handheld machine tool of claim 6, wherein a contact holder of the interface, which has the damping unit, which is provided to form an oscillation-damped contacting of a contact unit of the handheld machine tool energy supply unit.

8. The handheld machine tool of claim 6, wherein at least one locking element of the interface that has the damping unit and that forms an oscillation-damped locking of the handheld machine tool energy supply unit.

9. A system, comprising:
a handheld machine tool energy supply unit having an accumulator unit; and
a handheld machine tool, including an interface, having at least one damping unit to support the accumulator unit in an oscillation-damped manner, for connecting to an handheld machine tool energy supply unit having the accumulator unit.

10. A system, comprising:
a handheld machine tool energy supply unit, including:
an accumulator unit; and
an interface element having at least one damping unit to support the accumulator unit in an oscillation-damped manner; and
a handheld machine tool.

11. A system, comprising:
a handheld machine tool energy supply unit, including:
an accumulator unit; and
an interface element having at least one damping unit to support the accumulator unit in an oscillation-damped manner; and
a handheld machine tool, including an interface, having at least one damping unit to support the accumulator unit in an oscillation-damped manner, for connecting to the handheld machine tool energy supply unit having the accumulator unit.

12. The handheld machine tool energy supply unit of claim 1, wherein the handheld machine tool energy supply unit is a battery pack.

13. The handheld machine tool energy supply unit of claim 1, wherein the handheld machine tool energy supply unit is an accumulator pack.
